(19) United States
(12) Patent Application Publication
(10) Pub. No.: US 2009/0064515 A1
(43) Pub. Date: Mar. 12, 2009

(54) METHOD OF LEVELLING A PICTURE AND A PICTURE LEVELLING ASSEMBLY

(76) Inventor: Ken Parohl, Lloydminster (CA)

Correspondence Address: DAVIS & BUJOLD, P.L.L.C., 112 PLEASANT STREET, CONCORD, NH, 03301, US

(21) Appl. No.: 12/293,173

(22) PCT Filed: Oct. 3, 2006
(86) PCT No.: PCT/CA2006/001624

§ 371 Date: Sep. 16, 2008

(30) Foreign Application Priority Data
Mar. 17, 2006 (CA) 2,540,347

(51) Int. Cl. G01C 9/10

(52) U.S. Cl. 33/365

(57) ABSTRACT

A method of levelling a picture and a levelling assembly constructed in accordance with the teachings of the method. A first step involves suspending a picture (20) from a single mounting point (40) located at an upper portion of the picture (20). A second step involves securing at least one roller (22) to a lower portion (18) of the picture (20) to facilitate self levelling radial movement about the upper mounting point (40) by force of gravity.

### FIELD OF THE INVENTION

The present invention relates to a method of levelling a picture and a picture levelling assembly constructed in accordance with the teaching of the method.

### BACKGROUND OF THE INVENTION

It is common to see pictures hanging that are not level. With some picture hangers, vibrations passing along a wall caused by a closing of a door or the like, result in the picture shifting so that the picture is are no longer level.

### SUMMARY OF THE INVENTION

According to the present invention there is provided a method of levelling a picture. A first step involves suspending a picture from a single mounting point located at an upper portion of the picture. A second step involves securing at least one rollers, to a lower portion of the picture to facilitate self levelling radial movement about the upper mounting point by force of gravity.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a rear elevation view of a picture incorporating the levelling assembly constructed in accordance with the teachings of the present invention.

FIG. 2 is a perspective view of the weight positioned on the track of the levelling assembly shown in FIG. 1.

FIG. 3 is a partially exploded perspective view of the roller of the levelling assembly shown in FIG. 1.

FIG. 4 is a side plan view of a hanging nail.

FIG. 5 is an exploded perspective view of a variation of a roller mounting for the roller.

FIG. 6 is a perspective view of the variation of the roller mounting mounted on a picture.

FIG. 7 is a perspective view of the variation of the roller mounting being adjusted.

FIG. 8 is a perspective view of a variation of the weight and track.

### DETAILED DESCRIPTION OF THE PREFERRED EMBODIMENT

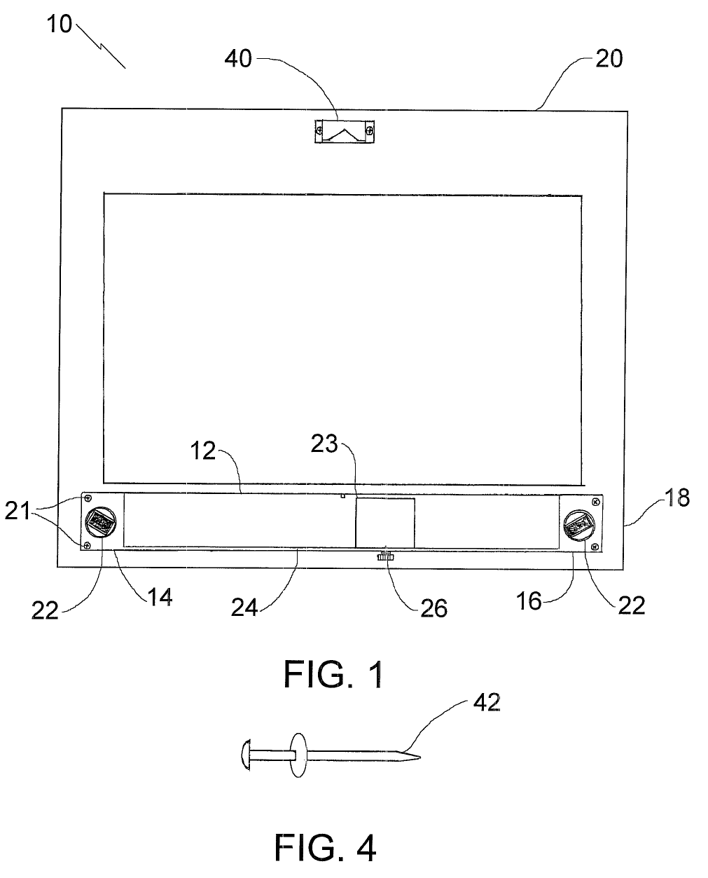

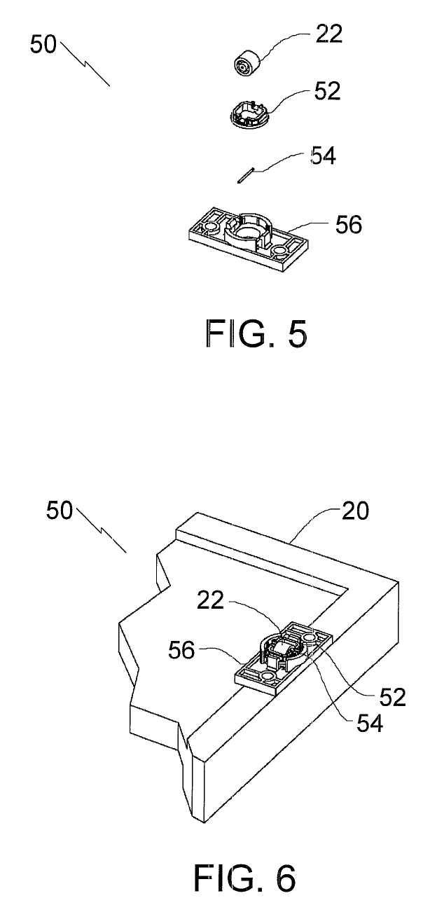

The preferred embodiment, a levelling assembly for a picture generally identified by reference numeral 10 developed in accordance with the teachings of the preferred method, will now be described with reference to FIG. 1 through 4. Variations will be discussed further on with respect to FIG. 5 through 8.

Structure and Relationship of Parts:

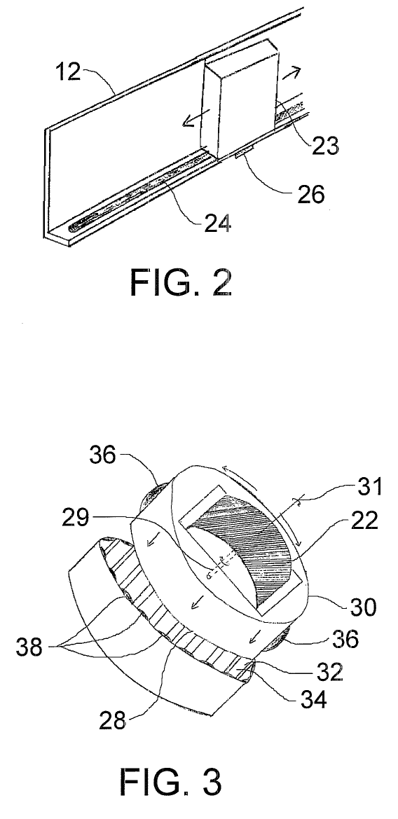

Referring to FIG. 1, levelling assembly 10 includes an elongated body 12 having a first end 14 and a second end 16. Body 12 is adapted to attach to a lower portion 18 of a picture 20, such as by screws 21. There are rollers 22 at each end 14 and 16 that are adapted to facilitate radial movement of lower portion 18 of picture 20 along a wall (not shown) on which picture 20 has been hung. Rollers 22 hold picture 20 a set distance from the wall to allow picture 20 to rotate freely to facilitate it returning to level if adjustment becomes necessary. A weight 23 is mounted on body 12 in a central position between first end 14 and second end 16. Referring to FIG. 2, weight 23 is positioned in a track 24 that allows selective sliding movement along track 24 toward first end 14 or second end 16 of body 12. Referring again to FIG. 1, track 24 is depicted as extending substantially the width of picture 20, although a shorter track that is centred on picture 20 would also suffice. There may be means provided to selectively adjust the positioning of weight 23 toward first end 14 or toward second end 16 of body 12 in order to accommodate asymmetrical imperfections in picture 20, or it may be done manually by simply sliding weight 23 toward one end or another. Means, such as a screw clamp 26 as depicted, may also be provided to secure weight 23 in the selected position, although it will be understood that other means of securing weight 23 are possible, such as a series of holes (not shown), with a pin biased by a spring outward into one of the holes that may be pushed out to allow weight 23 to be move in one direction or another and become secured in another hole. Alternatively, a spring biased knob may be used, where the contact surfaces of the knob and the track have an engaging profile such that the knob may be pulled down to allow the weight to slide, and released to secure the weight. Other means will be apparent to those in the art.

Referring to FIG. 3, each roller 22 is mounted to a hub 28 for rotational movement about a first axis. Hub 28 is then mounted within a housing 30 that has an interior 32 defining a circular hub receiving cavity 34. Hub 28 is thus mounted for rotational movement about a second axis that is perpendicular to the first axis, such that the angular position of each roller 22 is adjusted by rotating hub 28 within cavity 34. Means, such as bumps 36 that engage ridges 38 in the interior 32 of hub 28, are provided to secure hub 28 in a selected rotational position. Other means will also be apparent to those in the art.

Operation:

Levelling assembly 10 is provided as described above. Referring to FIG. 1, to hang picture 20 with levelling assembly 10, a hangar clip 40 is attached to the centre of picture 20 at the top. Other hangar clips 40 than the one shown may be used. Referring to FIG. 4, a nail 42 or screw is driven into the wall where picture 20 is to hang from. As it is important that there be sufficient space to permit picture 20 to move freely, the design of nail 42 ensures that it will not be driven into the wall too far. Other means may be used obtain a similar result. Referring to FIG. 1, levelling assembly is centred and attached to lower portion 18 of picture 20 by either screws 21, or other means such as sticky tape. Rollers 22 are then pulled out to disengage bumps 36 from ridges 38, and rotated such that axis 29 is parallel to a line connecting axis 29 to hangar clip 40 to allow picture 20 to rotate about hangar clip 40.

Picture 20 may then be hung on the wall by engaging hangar clip 40 and nail 42. Once picture 20 is hung, weight 23 is adjusted toward first end 14 or second end 16 to achieve a suitable orientation for picture 20. Weight 23 is then secured in the selected position by tightening screw clamp 26. Once installed, weight 23 is positioned such that picture 20 is biased by gravity toward the desired orientation, and picture 20 has three points of contact with the wall: two rollers 22, and nail 42. If picture 20 is moved from this orientation by vibration or by being bumped, rollers 22 allow picture 20 to rotate about nail 42 to return to the desired orientation. It will be noted that the above description is ideally suited for a wall with a smooth finish that allows rollers 22 to move freely. If the wall is not sufficiently smooth, steps may be required to ensure rollers 22 are able to move freely (e.g. the installation of a track or other smooth surface).

Variation:

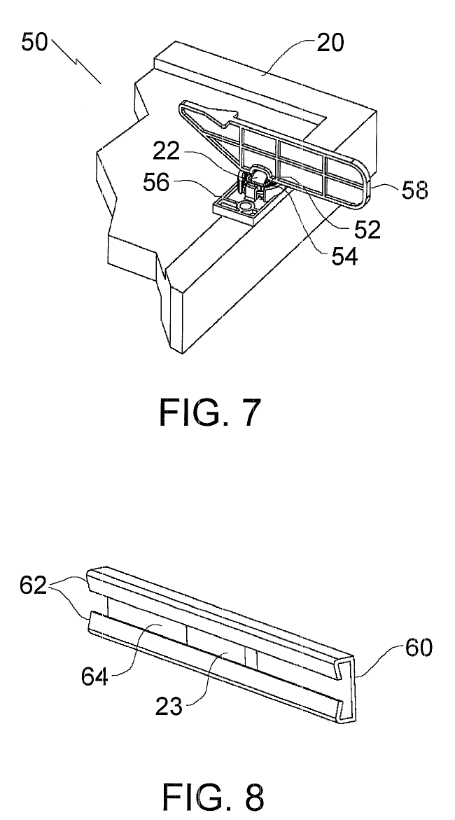

It will be understood that variations of the components above may be used. For example, a variation of the mounting for roller 22, denoted by reference numeral 50, is shown in FIG. 5 through 7. Referring to FIG. 5, mounting 50 includes roller 22, a wheel mount 52, an axle 54, and a bottom mount 56. As rollers 22 and weight 23 are separate pieces, assembly 10 may be installed on any size of picture 20. Referring to FIG. 6, bottom mount 56, which attaches to picture 20, receives wheel mount 52 in a manner such that wheel mount 52 is free to rotate within bottom mount 56. Wheel mount 52 in tarn attaches to axle 54 of roller 22. Referring to FIG. 7, a tool 58 is used to adjust the angular position of roller 22, which is done by rotating wheel mount 52 within bottom mount 56.

Referring to FIG. 8, weight 23 is also shown to be mounted in a different manner. As shown, weight 23 does not include a set screw, but rather is held within a channel 60 by two overlying tabs 62. Channel 60 and tabs 62 may be made from extruded plastic. Tabs 62 have a horizontal opening 64 in between, such that the position of weight 23 may be adjusted by accessing weight 23 through opening 64. UVeight 23 is held in position by tabs 62.

Definition:

It will be understood that the term “picture” is used in the broadest possible sense. The term picture includes diplomas and other framed items that may be completely text, without a graphic image. The term picture includes graphic images within frames and graphic images mounted on rigid substrates without frames.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the alt that modifications may be made to the illustrated embodiment without departing from the spirit and scope of the invention as hereinafter defined in the Claims.

1-11. (canceled)

12. A method of levelling a picture, comprising the steps of:
suspending a picture from a single mounting point (40) located at an upper portion of the picture;
securing at least one roller (22) to a lower portion (18) of the picture (20) to facilitate self levelling radial movement about the upper mounting point (40) by force of gravity; and
securing a weight (23) in a substantially central position to the lower portion (18) of the picture (20) to increase the force of gravity.

13. The method as defined in claim 12, there being more than one roller (22), with each roller (22) being spaced an equal radial distance from the single mounting point (40) about which the picture (20) swings.

14. The method as defined in claim 12, including a step of adjusting the positioning of the weight (23) to ensure that the picture (20) always returns to a level position notwithstanding asymmetrical imperfections in the frame.

15. The method as defined in claim 13, including a step of adjusting an orientation of each roller (22) to accommodate differences in the radial distance for different sizes of pictures.

16. A levelling assembly for a picture for use in accordance with the method of claim 12, comprising:
an elongated body (12) having a first end (14) and a second end (16), the body (12) being adapted for attachment to a lower portion (18) of a picture (20); and
rollers (22) at each of the first end (14) and the second end (16), the rollers (22) being adapted to facilitate radial movement of the lower portion (18) of the picture (20) along a wall on which the picture (20) has been hung.

17. The levelling assembly as defined in claim 16, wherein a weight (23) is mounted on the body (12) in a central position between the first end (14) and the second end (16).

18. The levelling assembly as defined in claim 17, wherein means (24) are provided to selectively adjust the positioning of the weight (23) toward the first end (14) or toward the second end (16) of the body (12) in order to accommodate asymmetrical imperfections in the picture (20), and means (26) are provided to secure the weight (23) in the selected position.

19. The levelling assembly as defined in claim 18, wherein the weight (23) is positioned in a track (24) that allows selective sliding movement along the track (24) toward the first end (14) or the second end (16) of the body (12).

20. The levelling assembly as defined in claim 19, wherein a screw clamp (26) serves as the means to secure the weight in the selected position along the track (24).

21. The levelling assembly as defined in claim 16, wherein each roller (22) is mounted to a hub (28) for rotational movement about a first axis (29), and the hub (28) is mounted within a housing (30) having an interior (32) defining a circular hub receiving cavity (34), the hub (28) being mounted for rotational movement about a second axis (31) perpendicular to the first axis (29), such that the angular position of each roller (22) is adjusted by rotating the hub (28) within the cavity (34), means being provided to secure the hub (28) in a selected rotational position.
